(19) United States
(12) Patent Application Publication
(10) Pub. No.: US 2012/0218606 A1
(43) Pub. Date: Aug. 30, 2012

(54) Image Processing Method and Image Processing Apparatus

(75) Inventor: Koichi ISHII, Shiojiri-shi (JP)

(73) Assignee: SEIKO EPSON CORPORATION, Tokyo (JP)

(21) Appl. No.: 13/363,078

(22) Filed: Jan. 31, 2012

(30) Foreign Application Priority Data
Feb. 25, 2011 (JP) 2011-039626

(51) Int. Cl. H04N 1/405

(52) U.S. Cl. 358/3.06

(57) ABSTRACT

An image processing method performs image process by using a supercell that includes a first cell forming a halftone dot, a second cell forming a halftone dot disposed adjacent to the first cell, and a third cell forming a halftone dot disposed further away from the first cell than the second cell, and in which the difference between a first angle where a first straight line, which connects the geometric center of the first cell with the geometric center of the second cell, crosses a reference line and a predetermined screen angle is larger than the difference between a second angle where a second straight line, which connects the geometric center of the first cell with the geometric center of the third cell, crosses the reference line and the screen angle.

### BACKGROUND

1. Technical Field

The present invention relates to an image processing method and an image processing apparatus that perform image processing, using a supercell composed of a plurality of cells that each forms a halftone dot having a size according to gradations, respectively.

2. Related Art

An image processing technology that reproduces the gradations of an image, using a plurality of cells (halftone dot cells) that is two-dimensionally arranged has been known in the related art. Each of the cells is constituted by a plurality of pixels that is two-dimensionally arranged and forms a halftone dot having a size according to the gradation value that the pixels each show. Further, as the cells form the halftone dots, the shade of an image is shown and the gradation of the image is reproduced.

Further, when a plurality of cells are two-dimensionally arranged, generally, the cells are arranged with a predetermined screen angle. In detail, the cells are arranged with a screen angle by shifting the cells, which are adjacent in the x direction, in a pixel unit in the y direction in an x-y plane forming a two-dimension. However, since this method provides the angle in the cell arrangement direction by shifting the cells in the pixel unit, there is a limit in matching the cell arrangement direction with a desired screen angle.

As described in JP-A-2006-067304, it is possible to increase the cell size (the number of pixels in the cells) to cope with the problem, but the increase causes another problem that the image quality is deteriorated. It has been attempted to remove the problems in JP-A-2006-067304 or Japanese Patent No. 3481423 by performing image process on each supercell composed of a plurality of cells. That is, as described in JP-A-2006-067304 and Japanese Patent No. 3481423, in those configurations, it is possible to make the arrangement direction of a plurality of halftone dots close to a screen angle while maintaining a delicate image quality by arranging the relatively fine halftone dots, which are formed by the cells of the supercell, in parallel in a predetermined arrangement direction.

However, even though supercells are used, it is difficult to completely match the arrangement direction of halftone dots with the screen angle and an error, called a quantization error, occurs in the arrangement direction and the screen angle. Further, the error may cause the following problem at the boundary of adjacent supercells. That is, there is a problem in that since the arrangement direction of the halftone dots in the supercells is not matched with the screen angle, arrangement of a plurality of halftone dots in one supercell and arrangement of a plurality of halftone dots in another supercell adjacent to the above supercell are not connected to each other, and accordingly, a deviation is generated in the arrangement of the halftone dots, at the boundary of the supercells.

### SUMMARY

An advantage of some aspects of the invention is to provide a technology that makes it possible to suppress a deviation in arrangement of halftone dots at the boundary between adjacent supercells.

According to an aspect of the invention, there is provided an image processing method performing image process by using a supercell that includes a first cell forming a halftone dot, a second cell forming a halftone dot disposed adjacent to the first cell, and a third cell forming a halftone dot disposed further away from the first cell than the second cell, and in which the difference between a first angle where a first straight line, which connects the geometric center of the first cell with the geometric center of the second cell, crosses a reference line and a predetermined screen angle is larger than the difference between a second angle where a second straight line, which connects the geometric center of the first cell with the geometric center of the third cell, crosses the reference line and the screen angle.

According to another aspect of the invention, there is provided an image processing method including: a storage unit storing a supercell that includes a first cell forming a halftone dot, a second cell forming a halftone dot disposed adjacent to the first cell, and a third cell forming a halftone dot disposed further away from the first cell than the second cell, and in which the difference between a first angle where a first straight line, which connects the geometric center of the first cell with the geometric center of the second cell, crosses a reference line and a predetermined screen angle is larger than the difference between a second angle where a second straight line, which connects the geometric center of the first cell with the geometric center of the third cell, crosses the reference line and the screen angle; and an image processing unit that performs image processing by using the supercell.

The first, second, and third cells are disposed in the supercell of the aspect of the invention (image processing method and image processing apparatus) having the configuration. Further, the second angle made by the second straight line, which connects the geometric centers of the third cell and the second cell from the first cell, and a straight line having the screen angle is smaller than the first angle made by the first straight line, which connects the geometric centers of the first cell and the second cell, and the straight line having the screen angle. When the supercell is used, it is possible to make the arrangement direction of the halftone dots in each of the supercells closer to the screen angle, such that it is possible to suppress the deviation of the halftone dot arrangement which is generated at the boundary of the adjacent supercells.

In the image processing method, a pattern where the first cell increases the size of the halftone dot in accordance with an increase in a gradation value and a pattern where the third cell increases the size of the halftone dot in accordance with an increase in a gradation value may be different. Therefore, it is possible to make the arrangement direction of the halftone dots in the supercell closer to the screen angle, such that it is possible to more effectively suppress the deviation of the halftone dot arrangement generated at the boundary of adjacent supercells.

### BRIEF DESCRIPTION OF THE DRAWINGS

The invention will be described with reference to the accompanying drawings, wherein like numbers reference like elements.

FIG. 1 is a view showing an embodiment of an image forming apparatus where the image process technology of the invention can be applied.

FIG. 2 is a block diagram showing the electric configuration of the image forming apparatus of FIG. 1.

FIG. 3 is a view schematically showing a deviation generated at the boundary of adjacent supercells.

FIG. 4 is a view illustrating an adjustment process of the size of a supercell.

FIG. 5 is a view showing a supercell before the size is adjusted.

FIG. 6 is a view showing in detail a plurality of cells constituting the supercell of FIG. 5.

FIG. 7 is a view showing size adjustment of a supercell.

FIG. 8 is a view showing size adjustment of a supercell.

FIG. 9 is a view showing size adjustment of a supercell.

FIG. 10 is a view showing size adjustment of a supercell.

FIG. 11 is a view showing size adjustment of a supercell.

FIG. 12 is a view showing size adjustment of a supercell.

FIG. 13 is a view comparing the images that are actually formed before and after the size adjustment.

### DESCRIPTION OF EXEMPLARY EMBODIMENTS

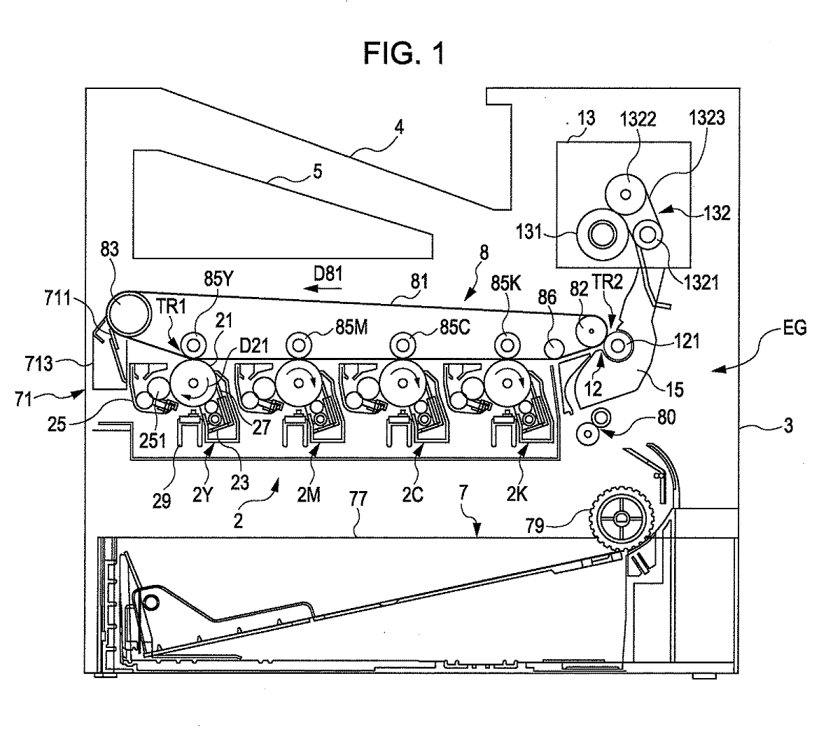

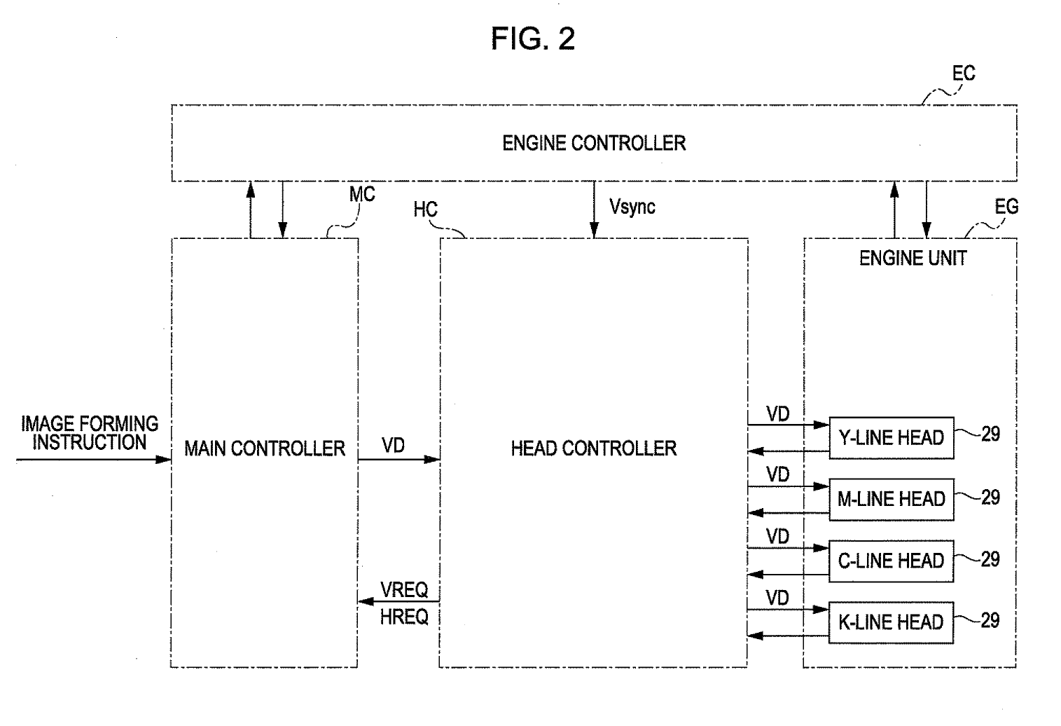

FIG. 1 is a view showing an embodiment of an image forming apparatus where the image process technology of the invention can be applied. FIG. 2 is a block diagram showing the electric configuration of the image forming apparatus of FIG. 1. The apparatus is an image forming apparatus that can selectively perform a color mode for forming a color image by overlapping four-color toner of yellow (Y), magenta (M), cyan (C), and black (K), and a monochrome mode for forming a monochrome image by using only the toner of black (K). In the image forming apparatus, when an image forming instruction is given to a main controller MC having a CPU or a memory from an external device, such as a host computer, the main controller MC sends a control signal to an engine controller EC, the engine controller EC performs a predetermined image forming operation by controlling the devices, such as an engine unit EG and a head controller HC on the basis of the control signal, and an image corresponding to the image forming instruction is formed on a sheet that is a recording material, such as copying paper, transfer paper, a sheet, and a transparent OHP sheet.

An electric component box 5 including a power circuit board, the main controller MC, the engine controller EC, and the head controller HC is disposed in a housing main body 3 of the image forming apparatus of the embodiment. Further, an image forming unit 2, a transferring belt unit 8, and a feeding unit 7 are also disposed in the housing main body 3. Further, a secondary transferring unit 12, a fixing unit 13, and a sheet guide member 15 are disposed at the right of the housing main body 3 in FIG. 1. Further, the feeding unit 7 is a member that is detachable/attachable with respect to the housing main body 3. Further, the feeding unit 7 and the transferring belt unit 8 can be separated and repaired or replaced.

The image forming unit 2 includes four image forming stations 2Y (yellow), 2M (magenta), 2C (cyan), and 2K (black) for forming images of a plurality of different colors. Further, in FIG. 1, the configurations of the image forming stations of the image forming unit 2 are the same, such that reference numerals are given to predetermined image forming stations for the convenience of drawing and the other image forming stations are not given reference numerals.

The image forming stations 2Y, 2M, 2C, and 2K are each equipped with a photosensitive drum 21 where a toner image is formed on the surface with each color. The photosensitive drum 21 has a rotary shaft that is disposed in parallel or substantially in parallel with the main scanning direction MD (the direction perpendicular to the paper in FIG. 1). Further, the photosensitive drum 21 is connected to an exclusive driving motor and rotated at a predetermine speed in the direction indicated by the arrow D21 in the figure. Accordingly, the surface of the photosensitive drum 21 is transported in the sub-scanning direction SD perpendicular or substantially perpendicular to the main scanning direction MD. Further, a charging unit 23, a line head 29, a developing unit 25, and a photosensitive cleaner 27 are disposed in the rotational direction around the photosensitive drum 21. Further, charging, forming of a latent image, and toner development are performed by the functional units. A color image is formed by overlapping toner images formed at all the image forming stations 2Y, 2M, 2C, and 2K on a transferring belt 81 in the transferring belt unit 8, when the color mode is performed. Further, when the monochrome mode is performed, a monochromic image of black is formed by operating only the image forming station 2K.

The charging unit 23 includes a charging roller having a surface made of elastic rubber. The charging roller is driven to rotate in contact with the surface of the photosensitive drum 21 at a charging position and driven to rotate by rotation of the photosensitive drum 21. Further, the charging roller is connected to a charge bias generating unit (not shown) and charges the surface of the photosensitive drum 21 to a predetermined surface potential, at the charging position where the charging unit 23 and the photosensitive drum 21 are in contact, by receiving charge bias from the charge bias generating unit.

The line head 29 is disposed such that the longitudinal direction LGD is in parallel or substantially in parallel with the main scanning direction MD and the lateral direction LTD is in parallel or substantially parallel with the sub-scanning direction SD. The line head 29 is equipped with a plurality of light emitting element arranged in the longitudinal direction LGD and disposed opposite the photosensitive drum 21. Further, light is radiated from the light emitting elements to the surface of the photosensitive drum 21 charged by the charging unit 23, thereby forming an electrostatic latent image on the surface.

The developing unit 25 includes a developing roller 251 that carries toner onto the surface. Further, charge toner is moved from the developing roller 251 to the photosensitive drum 21, such that the electrostatic latent image formed on the surface is actualized, at a development position where the developing roller 251 and the photosensitive drum 21 are in contact, by development bias applied to the developing roller 251 from a development bias generating unit (not shown) electrically connected with the developing roller 251.

The toner image actualized at the development position is transported to the transferring belt 81 in the rotational direction D21 of the photosensitive drum 21 and then primarily transferred at a primary transfer position TR1 where the transferring belt 81 and the photosensitive drums 21 are in contact.

Further, the photosensitive cleaner 27 is disposed downstream from the primary transfer position TR1 in the rotational direction D21 of the photosensitive drum 21 and upstream from the charging unit 23, in contact with the surface of the photosensitive drum 21. The photosensitive cleaner 27 removes the toner remaining on the surface of the photosensitive drum 21 after the primary transferring, by being in contact with the surface of the photosensitive drum.

The transferring belt unit 8 includes a driving roller 82, a driven roller 83 (blade-opposed roller) disposed at the right of the driving roller 82 in FIG. 1, and a transferring belt 81 held on the rollers and revolved in the direction of an arrow D81 (in a transport direction) by rotation of the driving roller 82. Further, the transferring belt unit 8 includes four primary rollers 85Y, 85M, 85C, and 85K opposite to the photosensitive drums 21 of the image forming stations 2Y, 2M, 20, and 2K, respectively, when being mounted in a cartridge, inside the transferring belt 81. The primary transferring rollers are electrically connected with primary bias generating units (not shown), respectively.

When the color mode is performed, as shown in FIGS. 1 and 2, the transferring belt 81 is pressed to come in contact with the photosensitive drums 21 of the image forming stations 2Y, 2M, 2C, and 2K and the primary transfer position TR1 is formed between the photosensitive drums 21 and the transferring belt 81, by positioning all the primary transferring rollers 85Y, 85M, 850, and 85K to the image forming stations 2Y, 2M, 2C, and 2K. Further, as primary transfer bias is applied to the primary transferring roller 85Y from the primary transfer bias generating unit at an appropriate timing, the toner images formed on the surface of the photosensitive drums 21 are transferred onto the surface of the transferring belt 81, at the corresponding transfer positions TR1, respectively. That is, in the color mode, monochrome toner images of the colors overlap each other on the transferring belt 81, such that a color image is formed.

Further, the transferring belt unit 8 includes downstream guide rollers 86 disposed downstream from the primary transferring roller 85K for black and upstream from the driving roller 82. The downstream guide roller 86 is in contact with the transferring belt 81, in a common of the primary transferring roller 85K and the photosensitive drum 21K for black, at the primary transfer position TR1 formed by the primary transferring roller 85K being in contact with the photosensitive drum 21 of the image forming station 2K.

The feeding unit 7 includes a feeder having a feeding cassette 77 that can store stacked sheets and a pickup roller 79 that feeds the sheets one by one from the feeding cassette 77. The sheet fed from the feeder by the pickup roller 79 is fed to a secondary transfer position TR2 where the driving roller 82 and a secondary transferring roller 121 are in contact, along a sheet guide member 15, after the feeding timing is adjusted by a pair of resist rollers 80.

The secondary transferring roller 121 is separably in contact with the transferring belt 81 and driven to be brought in contact or separated by a secondary transferring roller driving mechanism (not shown). The fixing unit 13 includes a heating roller 131 that includes a built-in heating body, such as a halogen heater, and can rotate, and a pressing unit 132 that presses the heating roller 131. Further, the sheet where an image is secondarily transferred on the surface is guided to a nipping portion composed of the heating roller 131 and a pressing belt 1323 of the pressing unit 132 by the sheet guide member 15, such that the image is fixed at a predetermined temperature at the nipping portion. The pressing unit 132 is composed of two rollers 1321 and 1322 and a pressing belt 1323 held by the rollers. Further, as the tension surface of the belt which is tightened by the two rollers 1321 and 1322, in the surface of the pressing belt 1323, is pressed against the circumferential surface of the heating roller 131, the nipping portion formed by the heating roller 131 and the pressing belt 1323 is widened. Further, the sheet that has gone the fixing process is transported to a discharge tray 4 disposed on the upper surface of the housing main body 3.

The driving roller 82 has the function of a backup roller of the secondary transferring roller 121 while revolving the transferring belt 81 in the direction of the arrow D81. A rubber layer having a thickness of about 3 mm and a volume resistivity of 1000 kΩ·cm or less is formed on the circumferential surface of the driving roller 82 and grounded through a metallic shaft, such that a conductive path of secondary transfer bias supplied through the secondary transferring roller 121 from the secondary transfer bias generating unit (not shown) is formed. As described above, as the rubber layer having high friction and shock absorption is disposed on the driving roller 82, it is possible to suppress deterioration of the image quality due to the shock transmitted to the transferring belt 81 when the sheet enters the secondary transfer position TR2.

Further, in the apparatus, a cleaner unit 71 is disposed opposite the blade-opposed roller 83. The cleaner unit 71 includes a cleaner blade 711 and a wasted toner box 713. The cleaner blade 711 removes foreign substances, such as toner or paper powder, which remains on the transferring belt 81 after the secondary transferring, by bringing the front in contact with the blade-opposed roller 83 through the transferring belt 81. Further, the foreign substances removed as described above are collected into the wasted toner box 713. Further, the cleaner blade 711 and the wasted toner box 713 are integrally implemented with the blade-opposed roller 83.

Further, in the embodiment, the photosensitive drums 21, the charging units 23, the developing units 25, and the photosensitive cleaners 27 of the image forming stations 2Y, 2M, 2C, and 2K may be integrated into a unit of a cartridge, respectively. Further, the cartridge can be detached/attached with respect to the apparatus main body. Further, a non-volatile memory for storing the information on the cartridge is disposed in the cartridge. Further, wireless communication is performed between the engine controller EC and the cartridges. Accordingly, the information on the cartridges is transmitted to the engine controller EC and the information in the memories is updated and stored. The use record of the cartridges or the lifespan of the consumables is managed on the basis of the information.

The schematic configuration of the image forming apparatus where the image processing technology of the invention can be implemented was described above. Next, an example of the image processing technology of the invention is described. The image processing is usually performed by the main controller MC. That is, when receiving an image signal from the outside, the main controller MC converts RGB data showing the gradation levels of RGB components of the pixels in an image corresponding to the image signal into CMYK gradation data showing gradation levels of the corresponding CMYK components. The input RGB gradation data is, for example, 8 bits per pixel and color component (that is, shows 256 gradations) and the output CMYK gradation data is also 8 bits per pixel and color component (that is, shows 256 gradations). The pixel is the minimum unit where a color material (toner) is printed on paper by the resolution of an engine unit EG.

Further, the main controller MC performs tone reproduction. The tone reproduction uses cells composed of a plurality of pixels that is two-dimensionally arranged, and in detail, forms a halftone dot having a size corresponding to the gradation value in each cell by comparing the threshold values corresponding to the pixels of the cells with the CMYK gradation data for each pixel. The halftone dot is a unit formed by one or a plurality of pixels and showing an area gradation. In particular, in the embodiment, as described in Japanese Patent No. 3481423, the tone reproduction is performed by using supercells implemented by combining a plurality of cells.

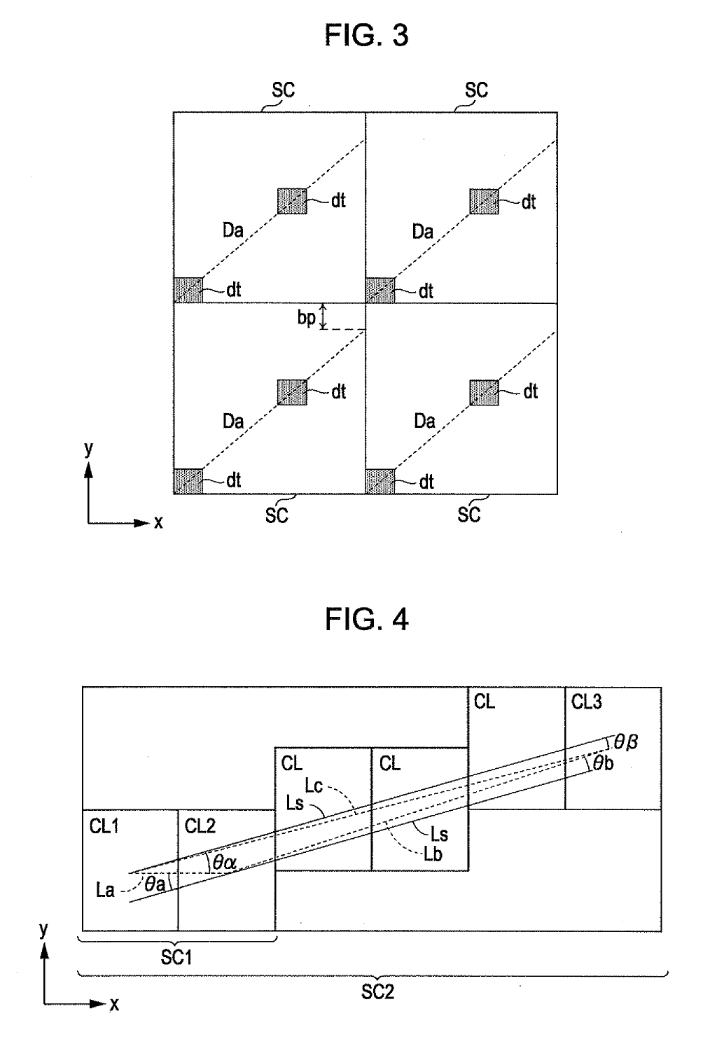

However, in the tone reproduction using the supercells, the arrangement direction of the halftone dots is not necessarily matched the screen angle due to a so-called quantization error. As a result, as described above, there is a problem in that a deviation by is generated in the arrangement Da of the halftone dots dt, at the boundary of adjacent supercells SC (FIG. 3).

FIG. 3 is a view schematically showing a deviation generated at the boundary of adjacent supercells. The x-axis shown in the figure indicates the main scanning direction and the y-axis indicates the sub-scanning direction. Further, in the embodiment, the screen angle is taken with respect to the x-axis. In the example shown in the figure, four supercells SC are two-dimensionally arranged in the x-y plane. Further, a plurality of halftone dots dt are disposed in parallel in the direction indicated by inclined dash lines in each supercell SC. However, the arrangement Da of the halftone dots is inclined with respect to the screen angle by the quantization error, such that the arrangement Da of the halftone dot of the supercells SC is not continued at the boundary of the adjacent supercells SC and a deviation by is generated between the arrangements in the y direction. The deviation by may be generated not only in the y direction, but the x direction. Further, the deviation by is shown as a stripe extending in the y direction or the x direction, in the resultant image.

In order to cope with the problem the main controller MC of the embodiment makes the arrangement of the halftone dots close to the screen angle and suppresses the generation of the deviation by by adjusting the size of the supercells SC. FIG. 4 is a view illustrating an adjustment process of the size of a supercell. In the figure, the straight line La (first straight line) is a virtual straight line connecting the geometric center of a cell CL1 with the geometric center of a cell CL2, the straight line Lb is a virtual straight line connecting the geometric center of the cell CL2 with the geometric center of a cell CL3, the straight line Lc (second straight line) is a virtual straight line connecting the geometric center of the cell CL1 with the geometric center of the cell CL3, and the straight line Ls is a virtual straight line having a screen angle with respect to the x-axis (reference line). First, the size of the supercell SC corresponds to two cells CL in the x direction, that is, considering the supercell SC1 in FIG. 4, the arrangement direction of the halftone dots dt is the arrangement direction of the cells CL1 and CL2, but the arrangement La of the cells CL1 and CL2 has a relatively large angle θα with respect to the straight line Ls having a screen angle (further, the angle made by the arrangement La of the CL1 and CL2 and the x-axis, which cross each other, corresponds to the “first angle” of the invention). On the other hand, the size of the supercell SC corresponds to six cells CL in the x direction, that is, considering the supercell SC2 in FIG. 4, the arrangement direction of the halftone dots dt is the arrangement direction of the cells CL1 and CL3, but the arrangement Lc of the cells CL1 and CL3 has a relatively small angle θβ with respect to the straight line Ls having a screen angle (further, the angle made by the arrangement Lc of the CL1 and CL3 and the x-axis, which cross each other, corresponds to the “second angle” of the invention). That is, the arrangement Da (=Lc) of the halftone dots is closer to the screen angle in the supercell SC2 than the supercell SC1. It is possible to make the arrangement Da (=Lc) of the halftone dots close to the screen angle by adjusting the size of the supercell SC, as described above. The size of the supercell SC is adjusted in the embodiment.

Further, whether the size of the supercell SC is appropriate can be estimated as follows. That is, from the concerned cell CL (cell CL2 in FIG. 4), when the virtual straight lines extending to the cells CL1 and CL3 at both ends of the supercell SC inclined substantially at the screen angle are La and Lb, the angle made by the virtual straight line La and the straight line Ls having a screen angle is θa, and the angle made by the virtual straight line Lb and the straight line Lb having a screen angle is θb, it is preferable to determine whether to satisfy the condition 1: |θa−θb|<δ1 and the condition 2: θa+θb<δ2, where δ1 and δ2 are values closed to 0. That is, when |θa−θb| satisfying the condition 1 is close to 0, the arrangement of the halftone dots dt (cell CL) shows favorable straightness, and when θa+θb is 0, the angle of the arrangement of the halftone dots dt (cell CL) is shown to be close to the screen angle. It is possible to estimate whether the sizes of the corresponding supercells SC are appropriate, by determining whether the conditions 1 and 2 are satisfied for the cells CL in the supercells SC.

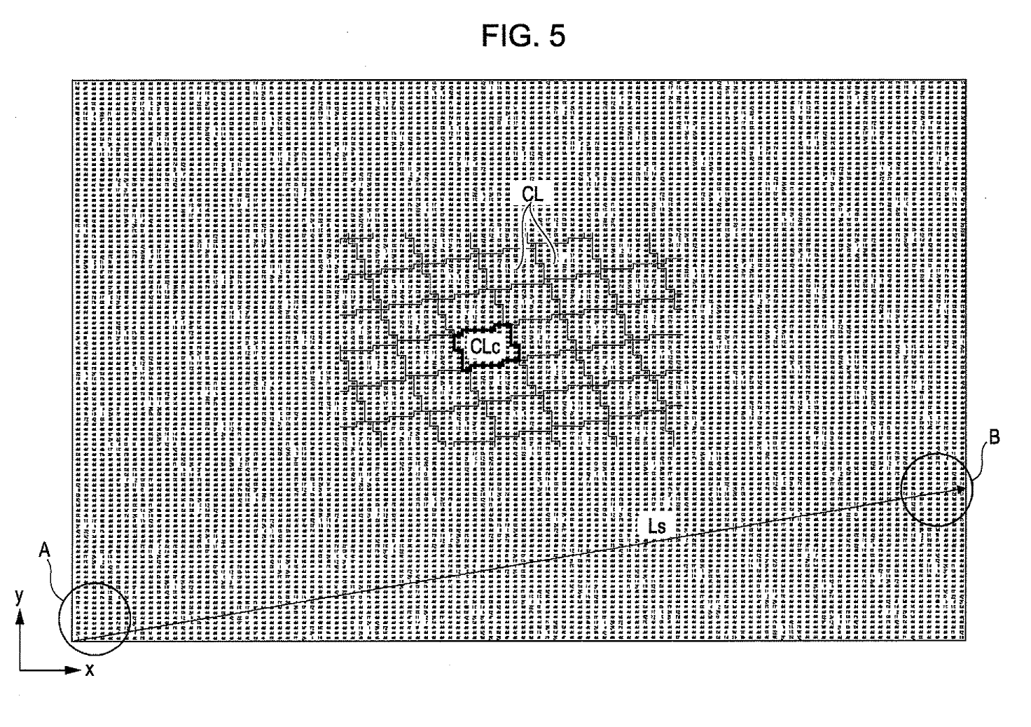

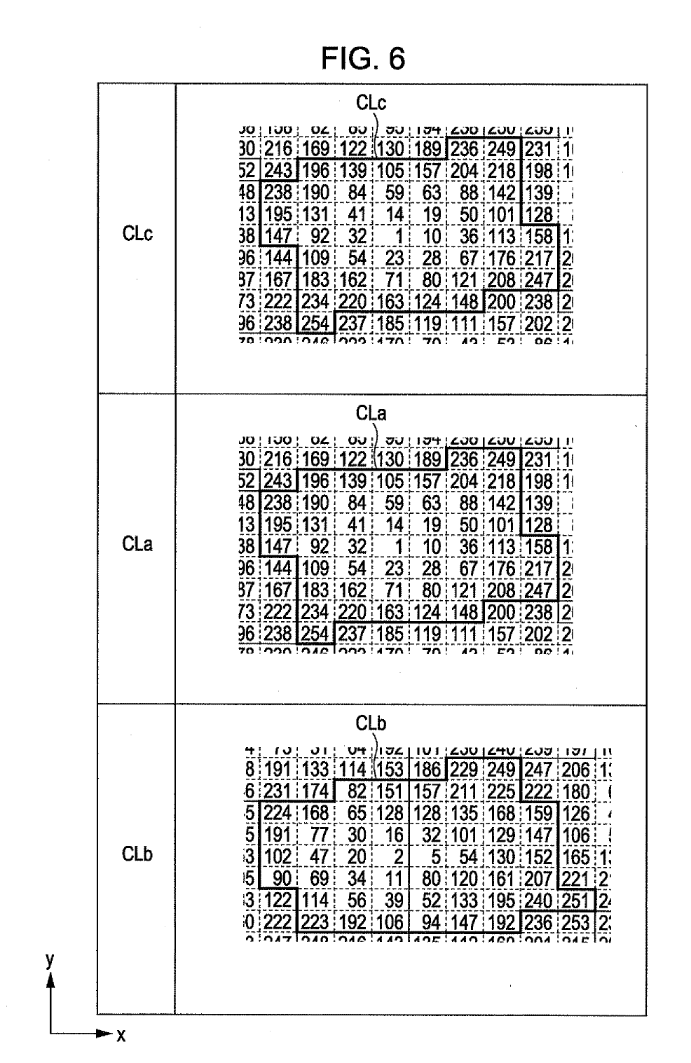

A more detailed size adjustment of the supercell SC, which is actually performed in the main controller MC is described. FIG. 5 is a view showing a supercell before the size is adjusted. Further, FIG. 6 is a view showing the detail of a plurality of cells constituting a supercell shown in FIG. 5, in which the column “CLc” in FIG. 6 shows the detailed configuration of a cell CLc of which the boundary is shown by a bold line at the center in FIG. 5 and the columns “CLa” and “CLb” in FIG. 6 show the detailed configurations of the cells CLa and CLb positioned at both ends A and B of the supercell of FIG. 5. Further, the threshold values of the pixels in the cells are also shown in FIG. 5. As can be seen from the figures, the supercell SC before being adjusted is composed of a plurality of kinds of cells having different numbers of pixels, shapes, and threshold values and stored in the memory in the main controller MC.

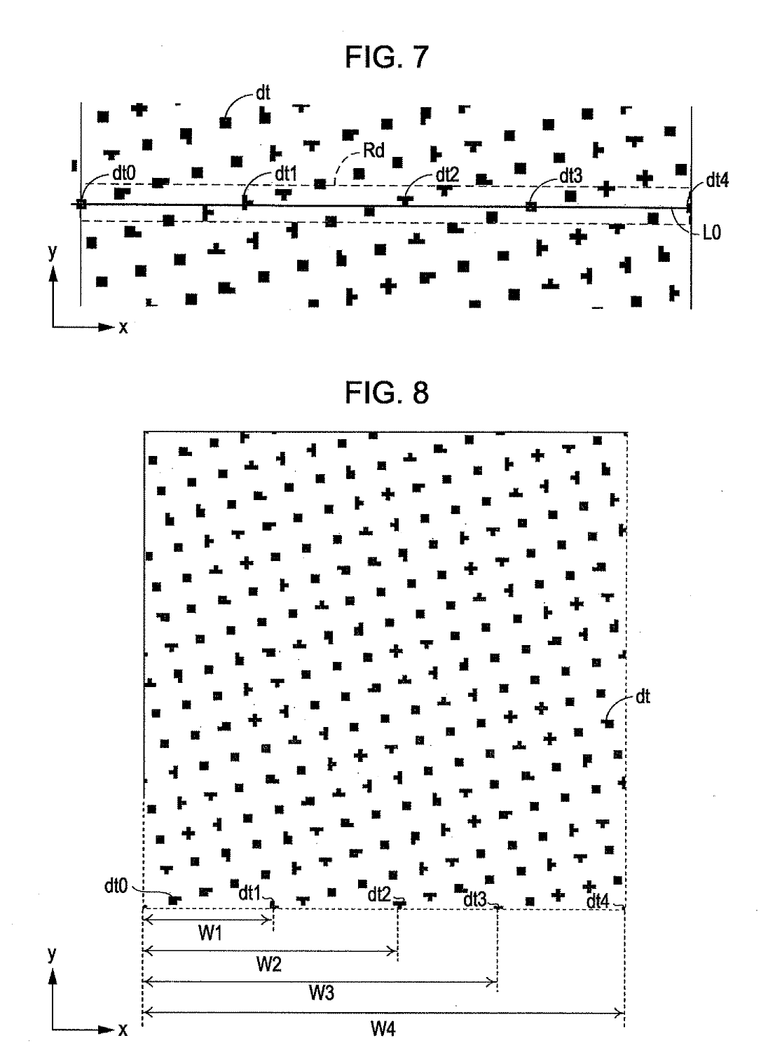

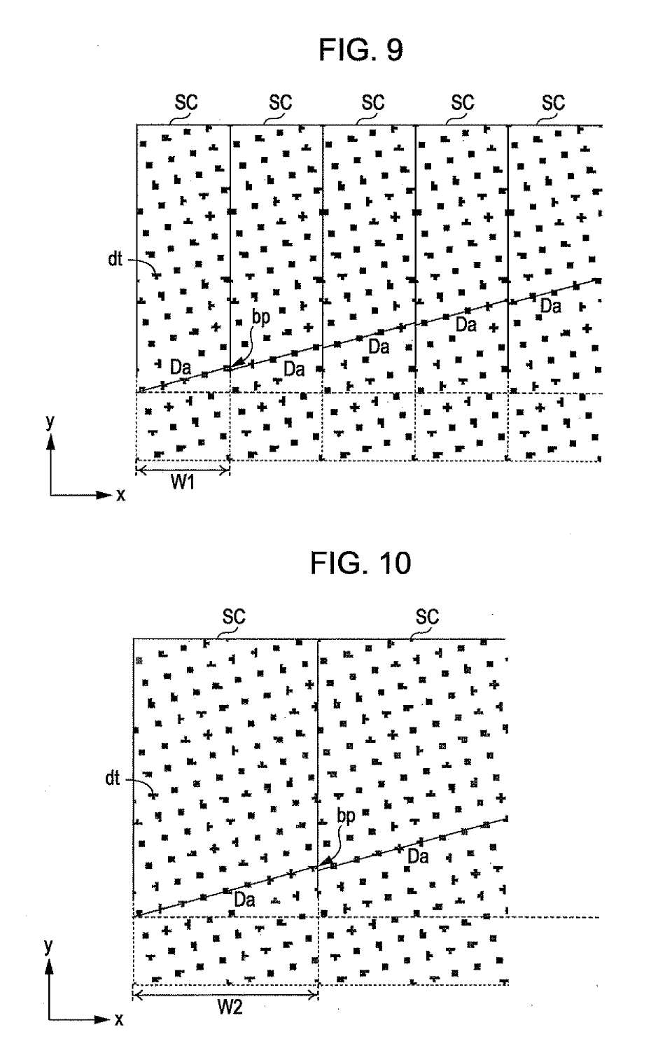

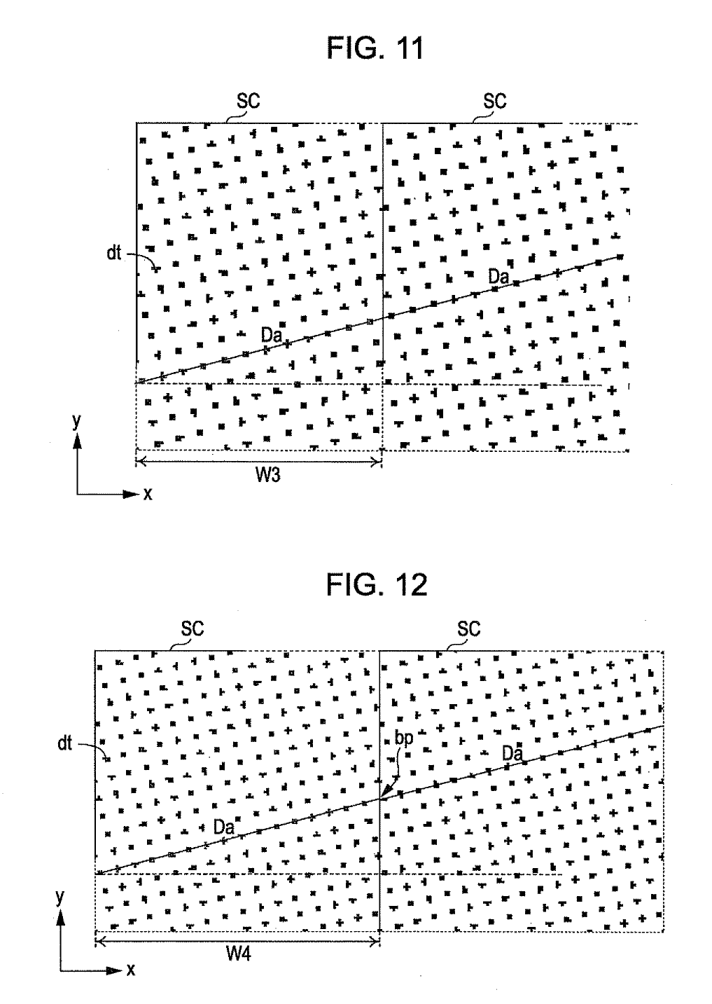

Further, the main controller MC adjusts the size of the supercell SC from the state of FIG. 6, by performing the operations shown in FIGS. 7 to 12. FIGS. 7 to 12 are views showing size adjustment of a supercell, in which the halftone dots formed by each cell CL are shown, instead of the cell CL. In the size adjustment, a searching range Rd within a predetermined distance in the y direction is set with respect to a straight line L0 extending in the x direction from a base halftone dot dt0, which is a base point. Further, close halftone dots dt1, dt2, dt3, and dt4, which are close to the straight line L0, are extracted from the search range Rd. In detail, for example, it is preferable to extract the halftone dot dt within a predetermined distance from the straight line L0 as a close halftone dot.

The following widths are set as choices for the width of the supercell SC in the x direction (FIG. 8),

Width W1: width from the base halftone dot dt0 to the close halftone dot dt1,

Width W2: width from the base halftone dot dt0 to the close halftone dot dt2,

Width W3: width from the base halftone dot dt0 to the close halftone dot dt3,

Width W4: width from the base halftone dot dt0 to the close halftone dot dt4.

Further, when a plurality of supercells SC having the widths W1 to W4 in the x direction are arranged (tiled) in the x direction, it is estimated whether the deviation by of the halftone dot arrangement Da, which is generated at the boundaries of the supercells SC adjacent in the x direction, is an allowable value Δbp or less. When the supercells SC having the widths W1, W2 and W4 are tiled, the deviation by is generated between the arrangements Da of the halftone dots, at the boundary of the adjacent supercells SC (bp>Δbp). On the other hand, when the supercell SC having the width W3 is tiled, the deviation by of the arrangement Da of the halftone dots is substantially suppressed (bp<Δbp), at the interface of adjacent supercells SC. The main controller MC sets the width W3 of the supercell SC in the x direction. Further, the main controller MC also sets the width of the supercell in the y direction in the same way. Further, tone reproduction is performed by the rectangular supercell SC with the size adjusted, as described above.

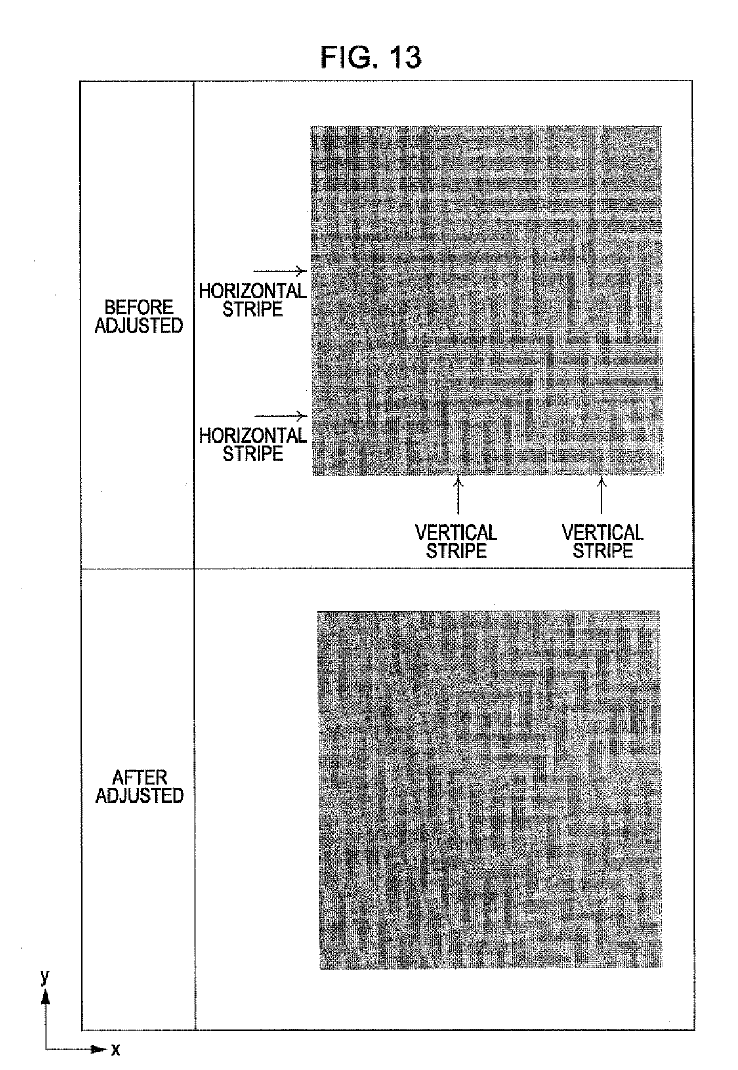

FIG. 13 is a view comparing the images that are actually formed before and after the size adjustment. As shown in the upper column “before adjusted” in the figure, white vertical stripes extending in the y direction and white horizontal stripes extending in the x direction are shown in the supercell SC before the size is adjusted, in the formed image. On the other hand, in the lower column “after adjusted” in the figure, the vertical stripes and the horizontal stripes are suppressed in the supercell SC after the size is adjusted.

As described above, in the embodiment both end cells CL1 and CL3 positioned at both ends of the supercell SC that is in parallel with the screen angle and the cell CL2 adjacent to the cell CL, between both end cells CL1 and CL3 have the following relationship. That is, as shown in FIG. 4, the angle θβ made by the virtual straight line Lc connecting the geometric center of the cell CL1 with the geometric center of the cell CL3 and the virtual straight line Lc having the screen angle is smaller than the angle θα made by the straight line La connecting the geometric center of the cell CL1 and the geometric center of the cell CL2 and the virtual straight line Ls having the screen angle. When the supercell SC is used, it is possible to make the arrangement direction of the halftone dots dt in the supercells SC closer to the screen angle, such that it is possible to suppress the deviation by of the halftone dot arrangement Da which is generated at the boundary of the adjacent supercells SC.

In other words, in the embodiment, since the arrangement Da of the halftone dots in the supercell SC is made far away from the screen angle by the quantization error, it is possible to suppress the problem that the deviation by is generated in the arrangement Da of the halftone dots, at the boundary of the supercells SC, by adjusting the sizes of the supercells SC.

Further, it may be possible to use PWM (Pulse Width Modulation) in order to suppress the problem due to the quantization error. However, in the embodiment, since it is possible to effectively cope with the problem by adjusting the size of the supercell SC, it is not necessary to dispose a module for PWM for performing PWM, such that the configuration can be simplified.

Further, in the embodiment, the pattern that increase the size of the halftone dots in accordance with an increase in the gradation values are different between both end cells CLa and CLb positioned at both ends of the supercell SC that is in parallel with the screen angle. Therefore, it is possible to make the arrangement direction of the halftone dots dt in the supercell SC closer to the screen angle, such that it is possible to more effectively suppress the deviation by of the halftone dot arrangement Da generated at the boundary of adjacent supercells SC.

As described above, in the embodiment, the cell CL1 corresponds to the “first cell” in the invention, the cell CL2 corresponds to the “second cell” in the invention, the cell CL3 corresponds to the “third cell” in the invention, and the main controller MC corresponds to the “storage unit”, the “image processing unit” or the “image processing apparatus” of the invention.

Further, the invention is not limited to the embodiments described above and may be modified in various ways without departing from the spirit of the invention. For example, in the embodiment, the main controller MC may perform the size adjustment of the supercell SC. However, the functional units, other than the main controller MC, may perform the size adjustment of the supercell SC.

Further, the type of the cells CL constituting the supercell SC is not limited to those described above and may be appropriately modified in various ways.

Further, resolution where the invention can be applied was not specifically stated in the embodiment. However, the invention may be applied to a print engine having resolution, for example, higher than 2400 dpi (dots per inch)×2400 dpi and a multi-resolution engine that can change resolution between resolution of 1200 dpi×1200 dpi and 2400 dpi×2400 dpi.

The entire disclosure of Japanese Patent Application No. 2011-039626, filed Feb. 25, 2011 is expressly incorporated by reference herein.

What is claimed is:

1. An image processing method performing image process by using a supercell that includes a first cell forming a halftone dot, a second cell forming a halftone dot disposed adjacent to the first cell, and a third cell forming a halftone dot disposed further away from the first cell than the second cell, and in which the difference between a first angle where a first straight line, which connects the geometric center of the first cell with the geometric center of the second cell, crosses a reference line and a predetermined screen angle is larger than the difference between a second angle where a second straight line, which connects the geometric center of the first cell with the geometric center of the third cell, crosses the reference line and the screen angle.

2. The image processing method according to claim 1,
wherein a pattern where the first cell increases the size of the halftone dot in accordance with an increase in a gradation value and a pattern where the third cell increases the size of the halftone dot in accordance with an increase in a gradation value are different.

3. An image processing apparatus comprising:
a storage unit storing a supercell that includes a first cell forming a halftone dot, a second cell forming a halftone dot disposed adjacent to the first cell, and a third cell forming a halftone dot disposed further away from the first cell than the second cell, and in which the difference between a first angle where a first straight line, which connects the geometric center of the first cell with the geometric center of the second cell, crosses a reference line and a predetermined screen angle is larger than the difference between a second angle where a second straight line, which connects the geometric center of the first cell with the geometric center of the third cell, crosses the reference line and the screen angle; and
an image processing unit that performs image processing by using the supercell.
